(19) United States
(12) Patent Application Publication
(10) Pub. No.: US 2016/0371662 A1
(43) Pub. Date: Dec. 22, 2016

(54) ADAPTIVE MERCHANT SITE SAMPLING LINKED TO PAYMENT TRANSACTIONS

(71) Applicant: EMPIRE TECHNOLOGY DEVELOPMENT LLC, Wilmington, DE (US)

(72) Inventor: Kevin S. Fine, Iverdon-les-Bains (CH)

(73) Assignee: EMPIRE TECHNOLOGY DEVELOPMENT LLC, Wilmington, DE (US)

(21) Appl. No.: 14/787,322

(22) PCT Filed: Feb. 4, 2015
(86) PCT No.: PCT/US15/14512

§ 371 Date: Oct. 27, 2015

(51) Int. Cl. G06Q 20/10; H04W 4/02; G06Q 20/20; H04L 29/08; G06Q 30/02

(52) U.S. Cl. CPC G06Q 20/102; H04L 67/22; G06Q 30/0201; G06Q 30/0202; G06Q 20/20; H04W 4/023

(57) ABSTRACT

Technologies are generally described to adaptively sample merchant sites linked to payment transactions to gain insight into activities, interactions, and behaviors of visitors within the merchant site. In some examples, a payment network may define a virtual perimeter that represents an area of the merchant site in which to capture selected measurements. The virtual perimeter and measurements may be transmitted to a client application being executed or executing on a portable device associated with a visitor. The client application may capture the measurements and transmit the captured measurements as tracking data to the payment network upon detection of a presence of the portable device within the virtual perimeter. Payment data processed by the client application may also be transmitted to the payment network. The payment network may process the payment and tracking data to perform a business intelligence analysis associated with the merchant site.

### BACKGROUND

Unless otherwise indicated herein, the materials described in this section are not prior art to the claims in this application and are not admitted to be prior art by inclusion in this section.

People interact with computer applications through user interfaces. While audio, tactile, and similar forms of user interfaces are available, visual user interfaces through a display device are currently the most common form of a user interface. With the development of faster and smaller electronics for computing devices, smaller size devices such as handheld computers, smart phones, tablet devices, and comparable devices have become common. Such portable devices are capable of executing a wide variety of applications ranging from communication applications to complicated analysis tools. Portable devices continually integrate technology to become further intertwined in a variety of daily tasks and processes. Sensors that encompass a variety of functions are integrated into portable devices with each new generation. Local applications rely oil environmental sensing technology captured by the portable device sensors to provide functionality to end-users. Furthermore, analysis applications process output data produced by such portable device sensors to generate intelligence analysis.

### SUMMARY

According to some examples, methods to provide adaptive merchant site sampling linked to payment transactions are described. An example method may include defining a virtual perimeter within a merchant site; selecting measurements to be captured within the virtual perimeter; transmitting the virtual perimeter and the measurements to a client application executed on a portable device associated with a visitor of the merchant site; and receiving a payment data processed by the client application. The method may further include receiving a tracking data, wherein the tracking data includes the measurements captured by the client application within the virtual perimeter and processing the payment data and the tracking data to generate a business intelligence analysis associated with the merchant site.

According to other examples, a portable device capable to adaptively sample a merchant site linked to payment transactions is described. An example portable device may include a wireless network device, a memory, and a processor coupled to the memory and the wireless network device. The processor may execute a merchant sampling application in conjunction with instructions stored in the memory. The merchant sampling application may be configured to receive a virtual perimeter and measurements to be captured within the virtual perimeter from a payment server; detect an entry of the portable device into the virtual perimeter; initiate capture of the measurements; detect a payment event at a payment terminal; transmit, through the wireless network device, a payment data associated with the payment event to the payment server; and detect an exit of the portable device from the virtual perimeter. The merchant sampling application may be further configured to stop capturing the measurements, wherein the captured measurements are packaged as a tracking data and transmit, through the wireless network device, the tracking data to the payment server to initiate operations to analyze the tracking data and the payment data to generate a business intelligence analysis by the payment server.

According to further examples, a payment server capable to analyze adaptive merchant site sampling linked to payment transactions is described. The payment server may include a network device, a memory, and a processor coupled to the memory and the network device. The processor may execute an analysis application, which may be configured to define a virtual perimeter within a merchant site select measurements to be captured within the virtual perimeter; transmit, through the network device, the virtual perimeter and the measurements to a client application executed on a portable device associated with a visitor of the merchant site; and receive, at the network device; a payment data processed by the client application. The analysis application may also be configured to receive, at the network device, a tracking data, where the tracking data includes the measurements captured by the client application within the virtual perimeter; and processing the payment data and the tracking data to generate a business intelligence analysis associated with the merchant site.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example high level diagram of a system configured to adaptively sample a merchant site linked to payment transactions;

FIG. 2 illustrates components of and processes used by a merchant sampling application configured to adaptively sample a merchant site;

FIG. 3 illustrates components of and processes used by a payment network configured to analyze sampled data at a merchant site;

FIG. 4 illustrates examples scenarios to adaptively sample a merchant site;

FIG. 5 illustrates an example of analysis of sampled data at a merchant site;

FIG. 6 illustrates a general purpose computing device, which may be used to implement adaptive sampling of a merchant site linked to payment transactions;

FIG. 7 is a flow diagram illustrating an example process to implement adaptive sampling of a merchant site linked to payment transactions that may be performed by a computing device such as the computing device in FIG. 6; and

FIG. 8 illustrates a block diagram of an example computer program product to adaptively sample a merchant site linked to payment transactions, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

Briefly stated, technologies are generally described to adaptively sample merchant sites linked to payment transactions to gain insight into activities, interactions, and behaviors of visitors within the merchant site. In some examples, a payment network may define a virtual perimeter that represents an area of the merchant site in which to capture selected measurements. The virtual perimeter and measurements may be transmitted to a client application being executed or executing on a portable device associated with a visitor. The client application may capture the measurements and transmit the captured measurements as tracking data to the payment network upon detection of a presence of the portable device within the virtual perimeter. Payment data processed by the client application may also be transmitted to the payment network. The payment network may process the payment and tracking data to perform a business intelligence analysis associated with the merchant site.

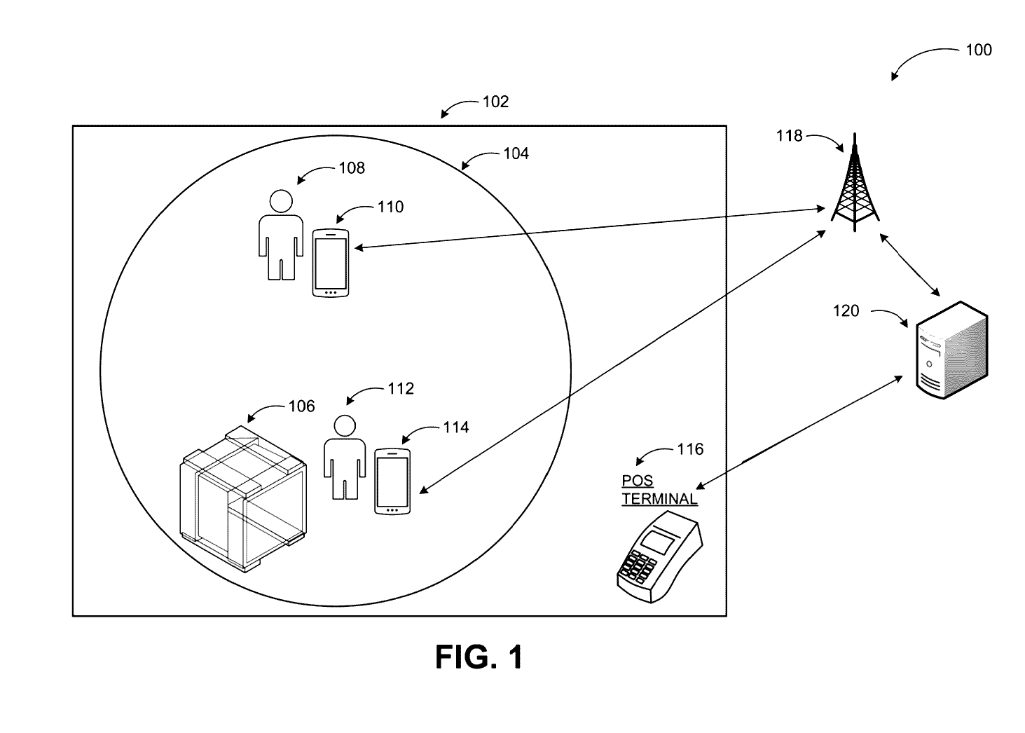

FIG. 1 illustrates an example high level diagram of a system configured to adaptively sample a merchant site linked to payment transactions, arranged in accordance with at least some embodiments described herein.

As shown in a diagram 100, a system may include a payment server 120. The payment server may be configured to analyze payment data captured by a point of sale (POS) terminal 116, and tracking data that includes measurements captured by client, applications executed on portable devices (110, 114) within a particular location of a merchant site 102. The particular location may be selected by the payment server 120 or a manager of the merchant site 102 as a virtual perimeter 104, where the virtual perimeter 104 may define boundaries of an area of the merchant site 102 in which measurements are to be captured. As illustrated, the virtual perimeter 104 may define a portion of the physical area of the merchant site 102. In other embodiments, the virtual perimeter 104 may define an entire physical area of the merchant site 102. The virtual perimeter 104 may also define an area surrounding or partially surrounding the merchant site 102, or a combination of any of the aforementioned. The merchant site 102 may include a store, a shopping mall, a business, a warehouse, and an outdoor location, for example, interested in gaining insight into activities, interactions, and behaviors by visitors, such as a customer and a user, among others.

According to embodiments, a visitor 108 may carry the portable device 110, which may have components, such as a client application and one or more sensors, to capture measurements within the virtual perimeter 104 of the merchant site 102. Another visitor 112 may carry the portable device 114, which may also have components, such as a client application and one or more sensors, to capture measurements within the virtual perimeter 104 of the merchant site 102. The capture of the measurements by the respective client applications may be dependent on the sensors, which may be on and/or integrated within the portable devices (110, 114), as well as software configured to operate the sensors installed on the portable devices (110, 114). Examples of the sensors may include position sensors, light sensors, microphones, and biometric sensors, among others. In response to detecting an entry of the portable devices (110, 114) into the virtual perimeter 104, the respective client applications may be configured to capture the measurements. The measurements may be associated with activities, interactions, and behaviors of the visitors (108, 112) with a product 106 within the virtual perimeter 104. Example measurements may include a position, an orientation, a low frequency magnetic field, pressure, an ambient light, a gesture, a sound, a radiofrequency connection, a cellular connection strength, a software activity, wearable attributes, and a power consumption.

The respective client applications may then be configured to transmit the captured measurements as tracking data to the payment server 120. The portable devices (110, 114) may be configured to communicate wirelessly. Accordingly, the respective client applications executed on the portable devices (110, 114) may communicate with the payment server 120 through a transmitter 118 that may route the wireless communications from the portable devices (110, 114) to the payment server 120. An example transmitter 118 may include a cellular antenna, or other wireless network device, configured to provide the communications between the portable devices (110, 114) and the payment server 120. The payment server 120 may then be configured to analyze the tracking data along with the payment data captured by the POS terminal 116 to generate a business intelligence analysis associated with the merchant site 102.

According to some embodiments, the payment server 120 may be configured to define the virtual perimeter 104 within the merchant site 102. Additionally, the payment server 120 may dynamically update the virtual perimeter 104 to expand or reduce a size of the virtual perimeter 104, or to change a shape of the virtual perimeter 104 based on demands of the generated business intelligence analysis associated with the merchant site 102. The payment server 120 may also be configured to select the measurements to capture within the virtual perimeter 104 of the merchant site 102. Similarly, the payment server 120 may update the selected measurements to change attributes, type, frequency or multitude of the measurements based on the demands of the generated business intelligence analysis associated with the merchant site 102.

Once selected by the payment server 120, the virtual perimeter and measurements may be transmitted from the payment server 120 to the respective client applications executed on the portable devices (110, 11.4). As previously discussed, the respective client applications may be configured to initiate capture of the measurements through activation of the sensors on and/or integrated within the portable devices (110,114). The capture of the measurements may be initiated in response to detection of an entry of the portable devices (110, 114) into the virtual perimeter 104. The respective client applications may be configured to stop the capture the measurements in response to detection of an exit of the portable devices (110, 114) from the virtual perimeter 104.

Two approaches may be used to detect the entry and exit of the portable devices (110, 114) into and from the virtual perimeter 104. In the first, portable device based approach, an application executed on the portable devices (110, 114) may access global positioning system (GPS) data to determine when the portable devices (110, 114) enter into and exit from the virtual perimeter 104. Furthermore, the accessed GPS data may be used to track movements of the portable devices (110, 114) within the virtual perimeter 104 to indicate visitor movements. The first approach may be more accurate (for example, an error margin of less than 10 meters), but may utilize battery power on the portable devices (110, 114). In the second, network based approach, the application on the portable devices (110, 114) accessing the GPS data may be discontinued upon tracking movement of the device(s) outside of the virtual perimeter, and location data may be provided by a mobile network operator. By discontinuing the application accessing the GPS data, the battery power on the portable devices (110, 114) may be preserved. Accuracy of network based approach may vary based on technique and network cell size, but general error margins are at least 100 meters. Accordingly, for the remainder of the application, we will discuss the first, more accurate, portable device based approach for detecting entry of the portable devices (110, 114) within the virtual perimeter 104.

The respective client applications may then be configured to transmit the captured measurements as tracking data to the payment server 120 through the transmitter 118. Additionally, the respective client applications may be configured to transmit payment data to the to the payment server 120 through the transmitter 118 in response to a completion of a payment transaction at the POS terminal 116. In some examples, the payment server 120 and the POS terminal 116 may comprise a payment network. Once the tracking data and the payment data have been received at the payment server 120, the payment network may process the tracking data and payment data to generate the business intelligence analysis. For example, the business intelligence analysis may provide information such as the product the visitors (108, 112) bought or did not buy and information as to why the purchase decision was made.

As previously discussed, the portable devices (110, 11.4) may include one or more sensors that when activated enable the capture of a variety of measurements during a time period as specified by the measurements. Table 1 below includes examples of measurements that may be selected, and types of sensors that may be used to enable the capture of such selected measurements. The examples provided below are not exclusive.

TABLE 1
Measurements that may be detected and/or
captured by a portable device

| Type | Sensor | Measurements |
|---|---|---|
| Position | Global Positioning | Merchant site tracking, |
| | System (GPS), | virtual perimeter |
| | Indoor Positioning | |
| | System (IPS) | |
| Orientation | Accelerometer, | Activities, emotional state, |
| | Magnetometer, | tracking |
| | Gyroscope | |
| Low Frequency | Magnetometer | AC (Alternating Current) |
| Magnetic Field | | Power signals |
| Pressure | Barometer | Weather, altitude |
| Ambient Light | Front and Back sensor | Day/night, sleep/awake |
| Gestures | Infrared | Emotional state, portable |
| | | device use |
| Sound | Microphone | voices, people in proximity, |
| | | sleep/awake, noise level |
| Radio Frequency | Wi-Fi, Bluetooth, | proximity of |
| (RF) Connections | Near Field | people/electronics, digital |
| | Communication (NFC) | surroundings |
| Cellular | 3G/4G radio | communication status |
| connection | | |
| strength | | |
| Software | Application Manager | applications used, portable |
| | | device activity |
| Wearable | Heartrate, pedometer | calories burned, excitement |
| | | level |
| Power | Onboard power meter | track power use |
| consumption | | |

In an example scenario, visitor tracking in the merchant site 102 may generate a business intelligence analysis, which may inform the merchant site 102 how to optimize floor plans, which displays may be ineffective, or how long visitors may look at merchandise before buying. If the merchant site 102 is busy, a small percentage of visitors may need to be tracked to generate the business intelligence analysis. As previously discussed, the payment server 120 may be configured to define and dynamically update the virtual perimeter 104, as well as select measurements, select different measurements for different visitors, and change the measurement selections over time. As a result, analysts may evolve methods and comprehension of the business intelligence analysis associated with the merchant site 102 based on changes to the virtual perimeter 104 and the measurements at the merchant site 102.

In addition to measuring position to obtain the visitors' movements within the merchant site 102, other measurements may be added to reveal purpose of the movements. For example, measurements associated with acceleration and low frequency magnetic field may be captured by sensors of portable devices (110, 114) to reveal how the visitors (108, 112) move or turn to see different products, such as the product 106, or bend to view a shelf Software tracking through an application manager of the portable devices (110, 114) may capture measurements of network use to indicate if the visitors (108, 112) went online to do comparison shopping. Capturing biological data, such as heart rate measurements, may additionally reveal if the visitors (108, 112) may be excited or lethargic.

The capability of the payment server 120 to modify and transmit the modified measurements to the respective client applications of the portable devices (110, 114) based upon analysis of previously captured measurements may be relevant. For example, in response to a detection of the visitor 112 pausing in front of the product 106 based on an analysis of position measurements, the payment server 120 may select to track power use measurements of the portable device 114 associated with the visitor 112. The selection of power use measurements may be transmitted to the client application executed on the portable device 114, and the power use measurements of the portable device 114 may be captured by an onboard power meter of the portable device 114. The captured power use measurements may be transmitted to the payment server 120 and analyzed to identify that the visitor 112 is often stopping to use the portable device 114. Then, the payment server 120 may select to track measurements associated with application use and portable device activity through an application manger of the portable device 114, which may indicate whether the visitor 112 uses the Internet on the portable device 114 while pausing.

In some examples, position may not be among, the main measurements. In a scenario where a visitor may be at a restaurant or a bar, the visitor's experience rather than the visitor's position within the restaurant or the bar may be more relevant. Accordingly, the payment server 120 may select to measure sound, such as a noise level. The selection to measure sound may be transmitted to client applications executed on one or more portable devices associated with visitors of the restaurant or the bar, and microphones of the portable devices may be configured to capture audio to indicate the noise level in the restaurant or the bar. Additionally and/or alternatively, measuring a level of acoustic energy may be used to estimate a number of visitors at the restaurant or the bar. Aggregation of the estimated number of visitors obtained from different portable devices associated with different visitors at the restaurant or the bar may provide an estimate of a popularity of the restaurant or the bar and how crowded the restaurant or the bar is at different times of the day. Combination of the estimation with payment data, such as what items are bought by the visitors and how much the items cost, may provide a comprehensive review of the restaurant or the bar.

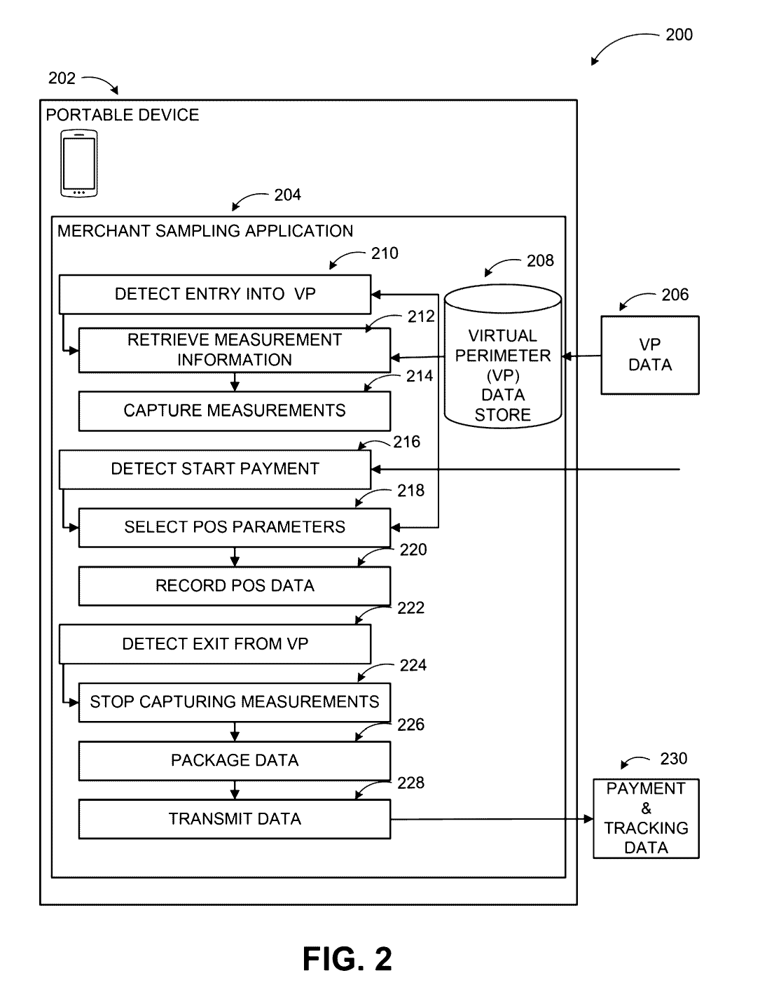

FIG. 2 illustrates components of and processes used by a merchant sampling application configured to adaptively sample a merchant site, arranged in accordance with at least some embodiments described herein.

According to some embodiments, in a diagram 200, a portable device 202 associated with a visitor of a merchant site may execute a client application, such as a merchant sampling application 204. The merchant sampling application 204 may be configured to receive virtual perimeter data 206 from a payment network. The virtual perimeter data 206 may include a virtual perimeter and one or more measurements to be captured within the virtual perimeter, where the virtual perimeter and measurements may be selected by the payment network. The virtual perimeter may define boundaries of an area of the merchant site in which the measurements are to be captured. The virtual perimeter may define an entire physical area of the merchant site or a portion of the physical area of the merchant site. In other examples, the virtual perimeter may define portions of multiple merchant sites. Example measurements to be captured within the virtual perimeter may include a position, an orientation, a low frequency magnetic field, a pressure, an ambient light, a gesture, a sound, a radiofrequency connection, a cellular connection strength, a software activity, wearable attributes, and a power consumption. The virtual perimeter data 206 may be stored within a virtual perimeter data store 208 associated with the merchant sampling application 204.

The merchant sampling application 204 may be configured to detect an entry 210 of the portable device 202 into the virtual perimeter. In response to the detected entry 210, the merchant sampling application 204 may retrieve corresponding information and attributes of the measurements 212 from the virtual perimeter data store 208, and capture the measurements 214 within the virtual parameter.

In addition to capturing the measurements, the merchant sampling application 204 may be configured to concurrently track a payment transaction. For example, the merchant sampling application 204 may detect a start payment 216 associated with a payment, or POS, terminal. In response to the detection of the start payment 216, the merchant sampling application 204 may select one or more POS parameters 218, and record POS data 220 based on the selected PUS parameters. The POS parameters 218 may include a position of the payment terminal, a form of the payment, a time of the payment, a number of products purchased, a list of the products purchased, and an amount of the payment, for example.

Upon completion of the payment transaction, the merchant sampling application may detect an exit 222 of the portable device 202 from the virtual perimeter. In response to the detection of the exit 222, the merchant sampling application 204 may be configured to stop the capture of the measurements 224, and package 226 the captured measurements as tracking data, along, with the recorded POS data as payment data. The payment and tracking data 230 may then be transmitted 228 over a secure internet connection to the payment network, where the payment and tracking data 230 may be processed to generate a business intelligence analysis. In some examples, the transmission of the payment and tracking data 230 may be delayed until a Wi-Ti connection is available to the portable device 202 in order to underutilize a cellular network data allotment. In other examples, the transmission of the payment and tracking, data 230 may be delayed until a time when the portable device 202 may be inactive. For example, late at night when the portable device is not being used by the visitor.

In some embodiments, payment and tracking data 230 processed by the payment network may inform a definition of new and/or modified virtual perimeters and measurements by the payment network. As a result, updated virtual perimeter data 206 including the new and/or modified virtual perimeters and measurements may be provided to the merchant sampling application 204, and stored within the virtual perimeter data store 208.

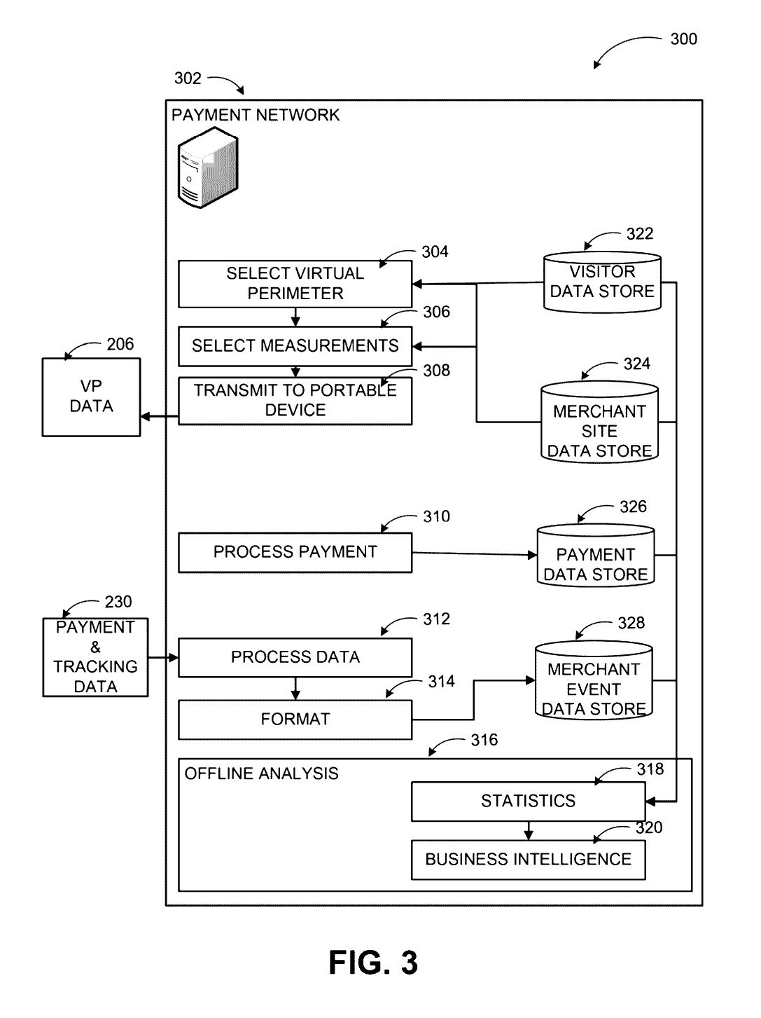

FIG. 3 illustrates components of and processes used by a payment network configured to analyze sampled data at a merchant site, arranged in accordance with at least some embodiments described herein.

A virtual perimeter, as described herein, may define boundaries of an area within a merchant site. As illustrated in a diagram 300, a payment network 302 may be configured to define a virtual perimeter 304 within a merchant site and one or more measurements 306 to be captured within the virtual perimeter of the merchant site. The defined virtual perimeter and measurements may be packaged as virtual perimeter data 206, as previously described in conjunction with FIG. 2, and transmitted to a client application, such as a merchant sampling application. The merchant sampling application may be executed on a portable device associated with a visitor of the merchant site. The visitor may be a customer of a business, for example. The merchant sampling, application may be configured to capture the selected measurements upon detection of an entry of the portable device into the defined virtual perimeter. The merchant sampling application may be further configured to transmit the captured measurements as tracking, data along with any payment data (the payment and tracking data 230) to the payment network 302. The payment and tracking data 230 may be transmitted to the payment network 302 upon detection of an exit of the portable device from the defined virtual perimeter. The payment network may then process and format the payment and tracking data 230 to be stored in as merchant event data store 328 of the payment network 302.

The payment network 302 may define the virtual perimeter 304 and select the measurements 306 based on information associated with the visitor and/or merchant site retrieved from a visitor data store 322 or a merchant site data store 324 of the payment network 302, respectively. For example, demographic information of the visitor, such as an age, a gender, an income status and a purchase history may influence the virtual parameter and measurements selected by the payment network, 302. In another example, information about a type of the merchant site, such as a retail store, a restaurant, or a service, may influence the virtual parameters measurements selected by the payment network 302. Accordingly, the measurements selected by the payment network 302 may differ between different visitors in different merchant sites. The payment network 302 may store the selected virtual perimeter and the measurements within the visitor data store 322 and the merchant site data store 324, in addition to transmitting the virtual perimeter and the measurements as virtual perimeter data 206 to the merchant sampling application.

Table 2 below is an example of the virtual perimeter data 206, comprising the virtual perimeter and measurements, transmitted from the payment network 302 to the merchant sampling application,

TABLE 2
Example of selected virtual perimeter and
measurements in virtual perimeter data.
Virtual Perimeter Location 33.566-117.667 (example coordinates)
Virtual Perimeter Radius 80 meters
Visit Measurements

| Measurements | Parameters |
|---|---|
| Heart rate | Sample rate 1.0 Hz |
| IPS Latitude, IPS Longitude | Sample rate 1.0 Hz |
| Sound A(t) | Sample rate 44100 Hz |
| POS Measurements | Sample Period 1.0 seconds |

As illustrated by the Table 2, the virtual perimeter may be transmitted to the merchant sampling application as a latitude, a longitude, and a radius. In some embodiments, more complicated shapes than circles may be possible, for example, polygons. Two types of measurements may be captured within the virtual perimeter. First, visit measurements, such as a heart rate of the visitor and a position of the visitor, may be captured for a duration of time that the visitor is within the virtual perimeter of the merchant site. Second, POS measurements may captured when the visitor is paying. Both the visit measurements and the POS measurements may be associated with parameters within the virtual perimeter data 206. The parameters may define how often to capture and/or record the measurements, including a frequency and/or amplitude for example.

For example, the PUS measurements may be recorded for a short definite time specified in the virtual, perimeter data 206, such as 1 second. The PUS measurements may include a form of payment, a time of the payment, a number of products purchased, a list of the products purchased, and an amount of the payment. Additionally, the PUS measurement limy include a precise position measurement, as the payment network 302 may determine which PUS terminal is being used, and where the POS terminal is located. Prior to capturing the POS measurements, a path at position) of the visitor through the merchant site may be estimated, where the estimate may include an offset. The path may be estimated from a combination of indoor positioning system (IPS) and GPS coordinates measured by sensors integrated with the portable device or dead reckoning from measured accelerations. However, once a payment transaction is detected, the payment network 302 may accurately identify a position of the PUS terminal. A current estimated path (or position) may be synchronized with the position data of the PUS terminal at the time of the payment event to remove the offset. As such, the path of the visitor may be identified precisely enough for the system to infer which product the visitor was viewing before making a purchase.

As previously discussed, the measurements selected by the payment network 302 may differ between different visitors in different merchant sites, in an example scenario, a manager of a store may be interested in tracking a visitor's shopping path in the store through positional measurements to determine an optimal arrangement of product displays. Contrastingly, a restaurant owner may be interested in tracking a visitor's experience in the restaurant through gesture, sound, and light measurements to determine visitor moods in response to restaurant ambience. Additionally, the type of measurements selected by the payment server 120 to be captured within the virtual perimeter of the merchant site may be targeted to match demands of a business intelligence analysis 320. The business intelligence analysis 320 may provide input to inform the definition of the virtual perimeter 304 and the selection of the measurements 306.

The business intelligence analysis 320 may be generated using a combination of information from the visitor data store 322, the merchant site data store 324, a payment data store 326, and the merchant event data store 328. As previously discussed, the visitor data store 322 and the merchant site data store 324 may store visitor and merchant site information, respectively, as well as information associated with virtual perimeters and measurements selected by the payment network 302 based on the associated visitor and merchant site information. The payment data store 326 may store information associated with processed payment transactions 310. The merchant event data store 328 may store the payment and tracking data 230 received from the merchant sampling application. For example, the payment and tracking data 230 may include movements of the visitor captured in the tracking data, ambient sound captured in the tracking data to detect a noise level, and biological data associated with the visitor captured in the tracking data to detect one or more moods of the visitor. The movements, ambient sound, and biological data captured may be analyzed to include in the business intelligence analysis 320. The combined information from the visitor data store 322, the merchant site data store 324, the payment data store 326, and the merchant event data store 328 may be analyzed in a statistics 318 module of an offline analysis 316 component of the payment network 302 to generate the business intelligence analysis 320.

The generated business intelligence analysis 320 may be sold by the payment network 302 to business clients, such as the merchant sites, interested in gaining insight to activities, interactions, and behaviors of visitors. In an example scenario, the generated business intelligence analysis 320 may instruct a store on how to better organize the store's layout to encourage increased visitor interaction, and accordingly increase product sales. Alternatively, the generated business intelligence analysis 320 may be sold to a third party, such as a restaurant review site Another business model may include the offline analysis 316 component to be processed by a third party to generate the business intelligence analysis 320 as a product for sale.

The payment and tracking data 230 may be anonymized by the payment network 302 to prevent targeted advertising of the visitor used for measurements. For example, the payment and tracking data 230 may be anonymized based on one or more privacy preferences of the visitor. The visitor's demographics may still be included, however. In an example scenario, the differences between typical store paths followed by single men, single women, and couples, among others may be analyzed to generate the business intelligence analysis 320. Many other demographic factors, such as age and income, may also be used to generate the business intelligence analysis 320.

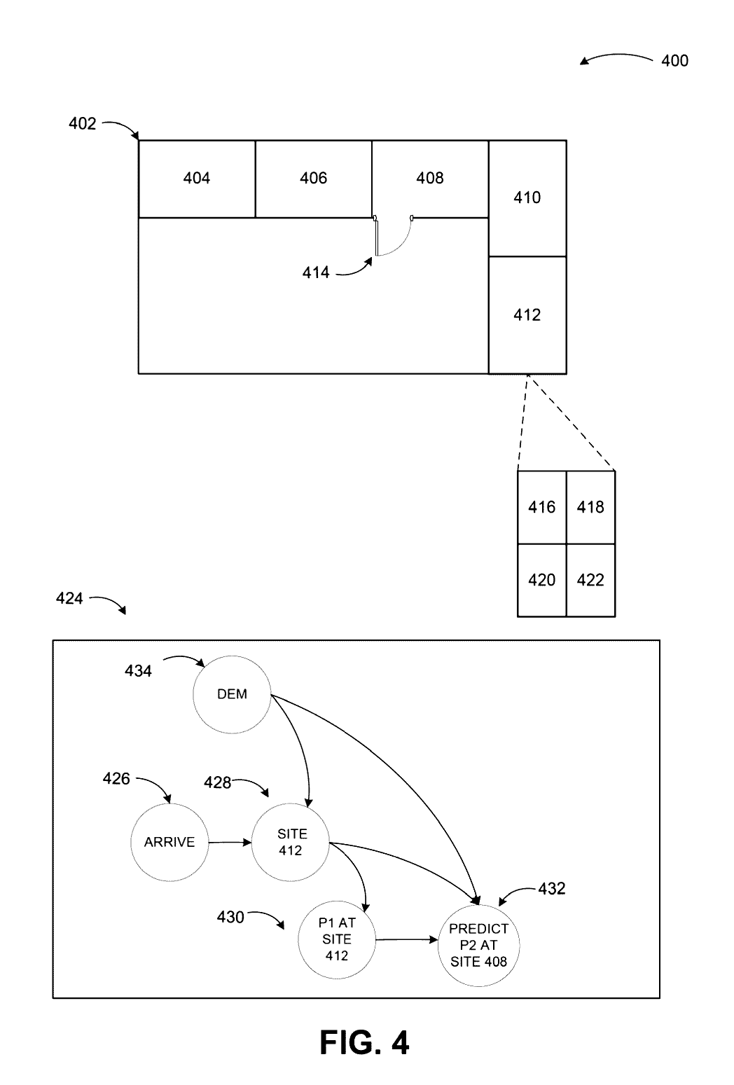

FIG. 4 illustrates examples scenarios to adaptively sample a merchant site, arranged in accordance with at least some embodiments described herein.

In a diagram 400, an example scenario to adaptively sample multiple merchant sites within a shopping mall 402 may be illustrated. The shopping mall 402 may have five merchant sites (404, 406, 408, 410, and 412). A manager of the merchant site 408 may wish to increase sales. The manager may suspect that visitors to the shopping mall may trip chain (that is, visit multiple merchant sites one after another) in a pattern. Identifying the pattern in which the visitors visit the merchant sites may help to optimize the merchant site 408. For example, the pattern may indicate that visitors often first visit the merchant site 412. Based on the pattern, the merchant site 408 may choose to rearrange a location of products within the merchant site 408 such that products commonly sought from the merchant site 412 are re-located near a door 414 in sight of the visitors. The enhanced visibility of the products may encourage the visitors to purchase the products from the merchant site 408. In another example, a few of the products of interest may be displayed near the door 414, but may be employed as destination items in a back location of the merchant site 408 in order to cause the visitors to pass by other products that the visitors may purchase.

A payment network may be configured to generate the pattern (that is, generate business intelligence) for clients, such as the manager of the merchant site 408, interested in gaining, insight to activities, interactions, and behaviors by visitors. The payment network may be configured to define multiple virtual perimeters to define boundaries for an area of each of the merchant sites (404, 406, 408, 410, and 412) within the shopping mall 402. In some examples, the virtual perimeters may define an entire physical area of each of the merchant sites (404, 406, 408, 410, and 412). Alternatively, the virtual perimeters may define a portion of the area of each of the merchant sites (404, 406, 408, 410, and 412). For example, the virtual perimeter for merchant site 408 may include the portion of the merchant site 408 where products are displayed and purchased. Stock and/or inventory areas and employee break areas may not be included within the virtual perimeter. The payment network may further be configured to select measurements to be captured within respective virtual perimeters for each of the merchant sites (404, 406, 408, 410, and 412). The payment network may be configured to transmit the defined virtual perimeters and corresponding measurements to be captured within each defined virtual perimeter to a client application, such as a merchant sampling application. The merchant sampling application may be executed on a portable device associated with a visitor of the shopping mall 402.

In some embodiments, the virtual perimeters may be divided into sub-regions to allow the capture of measurements to be specific to a sub-region. For example, the merchant site 412 may be divided into 4 sub-regions (416, 418, 420, and 422), as illustrated. However, a total number of virtual perimeters may be limited based on capabilities of the portable device. For example, hardware limitations of the portable device may set an upper ceiling, to the number of virtual perimeters at a merchant site. As such, virtual perimeters may be dynamically updated to accommodate the upper ceiling on the number of virtual perimeters that the portable device may manage.

As the visitor moves throughout the shopping mall 402, the merchant sampling application may be configured to detect entry of the portable device into each of the defined virtual parameters through one or more position sensors integrated within the portable device. In response to the detection of the entry into one of the defined virtual perimeters, the respective measurements may be captured in the defined virtual perimeter. The respective measurements may be continuously captured until the merchant sampling application detects an exit of the portable device from the defined virtual parameter. The captured measurements may be packaged as tracking data, and transmitted to the payment network. In addition to capturing measurement information, the merchant sampling application may capture payment data associated with payment transactions within each of the defined virtual perimeters. The payment data may be transmitted along with the tracking to the payment network. The payment network may be configured to process the payment and tracking data associated with each virtual perimeter to generate a business intelligence analysis associated with the respective merchant sites (404, 406, 408, 410, and 412). The business intelligence analysis may inform about activities, interactions, and behaviors of visitors within and among the merchant sites (404, 406, 408, 410, and 412), for example.

In one embodiment, a behavior of the visitors within the virtual perimeter as detected in the payment data and the tracking data may be predicted with graph based probability models. An example scheme may include a Bayesian net model 424, as illustrated in the diagram 400. The Bayesian net model 424 may be used to predict a product that a visitor may purchase within the merchant site 408 by measuring a path of the visitor through one or more of the other merchant sites (404, 406, 410, and 412). Other state based models, such as Hidden Markov Models (HMMs), Hierarchical Dirichlet Process Models (HDPM), and Dynamic Bayesian Nets, among others, may also be used to predict products that the visitor may purchase within one of the merchant sites (104, 406, 408, 410, and 412).

In the Bayesian net model 424, each circle may represent a variable that may be measured or a hidden variable which may not be measured. The arcs may represent dependencies. In the Bayesian net model 424, the visitor may arrive 426 at the shopping mall 402. The visitor may initially shop at a merchant site S1 (428), which may correspond to any of the merchant sites other than merchant site 408. For the following example, S1 (428) may correspond to merchant site 412. At the merchant site S1 (428), the visitor may make a purchase P1 (432). The variables may be assigned multiple values. For example, the purchase variable, P1 (432), may include a cost value, and a type value. The purchase variable type values may be divided into multiple general categories, such as food, entertainment, or electronics, among others. A purchase variable type value may be assigned to a category 0 if a visitor does not purchase a product. One or more demographics 434 associated with the visitor may also be captured, and divided into a variety of categories and labels, such as gender, marital status, age, race, and income. The Bayesian net model 424 may be configured to predict what the visitor may purchase, P2 (432), at the merchant site 408 based upon S1 (428), P1 (432), and the demographics 434 associated with the visitor.

Each circle may include a table of joint distributions. The table of joint distributions may provide probabilities for all states of a variable for all combinations of inputs. Distributions may be updated as data, such as the payment and tracking data, is consumed. Such a scheme is called parameter learning. A classic scheme for parameter learning that may manage hidden variables is called an Expectation-Maximization (EM) scheme. The EM scheme may also extract useful information when some of the variables are missing in a measurement. In addition, the graph may be evolved. There are several different machine learning schemes to learn optimal Bayesian Net models, such as K2 and Greedy Learner algorithms. Several variations of the model may be created to evaluate how well each matches the data using, a scoring parameter.

After the Bayesian net model 424 is trained with updated data, the model may be analyzed to find relevancy of target variables, where relevant target variables may correspond to measurements selected by the payment network to be captured within the virtual perimeters. The target variables may explain the variables of interest identified by one of the payment network and the manager of the merchant site 408. For example, the variable of interest may be the predicted purchase, P2 (432) of the visitor at the merchant site 408, while the target variables may be the merchant site, S1 (428), previously visited by the visitor, the purchase, P1 (430), made within the previously visited merchant site, S1 (428), and/or the demographics 434 of the visitor.

One measure of relevancy may be a Conditional Bayes Factor (CBF). The CBF may provide a measure of the relevance of target variables for prediction. Using CBF along with limits may separate out relevant and irrelevant variables from the rest. Alternatively, a simpler measure based upon correlation may be sufficient to determine relevancy. Target variables which may be statistically independent of the variables of interest do not have predictive power, and may be irrelevant. For example, if visitors entering the merchant site 408 from the merchant site 406 buy products within the merchant site 408 similarly to the average of all other visitors who did not enter the merchant site 408 from the merchant site 406, then distinguishing previously visited merchant site 406 as a target variable may not be relevant. Irrelevant variable states, such as the previously visited merchant site 406, may be eliminated to reduce the data load and virtual perimeters. In contrast, relevant variables may be subdivided and new virtual perimeters may be defined. For example, a previously visited merchant site 412 may be a relevant variable because the visitors spend differently at the merchant site 408 after having visited the merchant site 412. As such, the virtual perimeter for the merchant site 412 may be refined. Alternatively, the virtual perimeter for the merchant site 412 may be subdivided into multiple virtual parameters, such as the 4 sub-regions (416, 418, 420, and 422) previously discussed. As such, the graph node of the merchant site S1 (428) may correspond to the merchant site 412 and may include 4 merchant sites instead of 1.

The multiple sub-regions (416, 418, 420, and 422) of the merchant site 412 may used to refine relevancy of portions of the original virtual perimeter. For example, as measurements are captured and consumed, a visitor who entered the virtual perimeter corresponding to the sub-region 420 may be detected to have also bought a product at the merchant site 408. The virtual perimeter corresponding to the sub-region 420 may be further refined to detect what products the person viewed and/or interacted with while within the sub-region 420 at the merchant site 412. At any point, each virtual perimeter corresponding to a sub-region may be detected to have identical behavior, and in response, a largest relevant virtual perimeter may be processed. Such dynamic tuning of virtual perimeters may provide arbitrary and continuously increasing precision beyond what a static virtual perimeter system may attain.

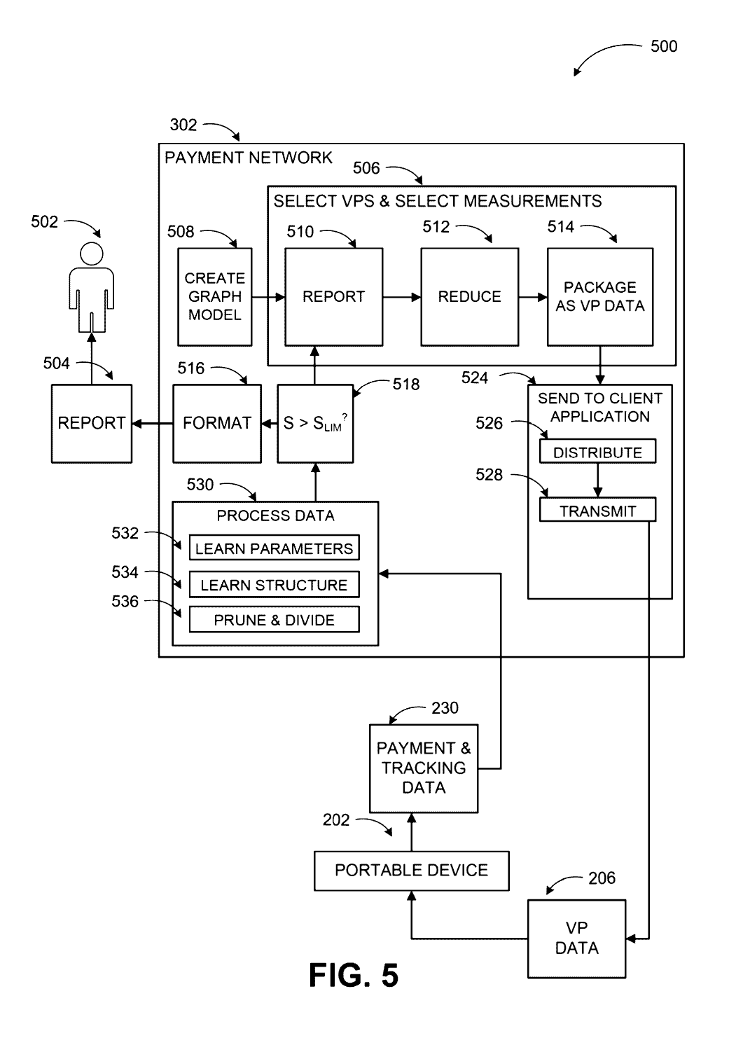

FIG. 5 illustrates an example of analysis of sampled data at a merchant site, arranged in accordance with at least some embodiments described herein.

In a diagram 500, a manager 502 of a merchant site may create a list comprising variables of interest, and input the list into a payment network 302 in order to create a graph model 508, such as a Bayesian net. As previously discussed in conjunction with FIG. 4, the payment network 302 may be configured to determine one or more target variables to be incorporated within the graph model that may be able to explain the variables of interest, in order to predict the variables of interest.

The payment network 302 may be further configured to define virtual perimeters and one or more measurements 506 based on the created graph model 508. The virtual perimeters may define boundaries of areas within the merchant site in which the measurements are to be captured. The variables of interest and target variables within the created graph model 508 may influence the virtual perimeters and measurements that may be selected by the payment network. The measurements that can be captured by a portable device 202 may be extracted in a report 510 along with the associated virtual perimeters in which the measurements are to be captured. The extracted measurements from the report 510 may then be reduced to a list comprising their associated virtual parameters and events that that occur within the virtual perimeters, such as an entry of the portable device 202, and exit of the portable device 202. The list may be packaged for transmission as virtual perimeter data 514.

The virtual perimeter data 514 may be sent to a client application 524 executed on a portable device associated with a visitor of the merchant site. However, the number of virtual perimeters capable of being detected by the portable device 202 may be limited by hardware capabilities of the portable device 202. As such the virtual perimeters and measurements within the virtual perimeter data 514 may be first divided into subsets and distributed 526 among the visitor and multiple other visitors associated with other portable devices within the merchant site. For example, the subsets may be distributed pseudo-randomly among the visitors. Alternatively, a Bandit Epsilon Greedy scheme may be used for more efficient distribution. In such an approach; the subsets may be distributed equally, then as merchant site sampling progresses the subsets that yield more useful intelligence results may be favored, eventually eliminating, less useful subsets. In response, virtual perimeters corresponding, to the subsets may be dynamically updated.

The virtual perimeter data, comprising the distributed subset of virtual perimeters and measurements to be captured within each of the virtual perimeters, may be transmitted 528 to the client application executed on the portable device 202 associated with the visitor. The client application may be configured to capture respective measurements through activated sensors on and/or integrated within the portable device 202 in response to detecting an entry of the portable device 202 into each virtual perimeter. In response to detecting an exit of the portable device from each virtual perimeter, the client application may be configured to stop capturing respective measurements, and package the captured measurements as tracking data. The client application may then be configured to transmit the payment and tracking data 230 (if the visitor purchased a product within the virtual perimeter) to the payment network 302 to be processed 530.

A new and/or modified graph model to determine virtual perimeter and measurement selection may be learned from the payment and tracking data 230 during processing. A table of joint distributions of the created graph model, providing probabilities for all states of each variable for all combinations of inputs, may be adjusted based on learned parameters 532. A new and/or modified graph model structure may be selected, based on a learned structure, and the selected measurements and associated virtual perimeters may accordingly be altered 536 based on the new and/or modified graph model.

The new and/or modified graph model may continue to evolve until the model has sufficient predictive power. Sufficient predictive power may be measured by a scoring parameter, S, which may be tested 518. Several scoring, parameters may exist such as a Bayesian Information Criterion (BIC) and BDe. If the scoring parameter limit (Sum) is not exceeded, the modeling process may continue, with an informed definition/selection of new and/or modified virtual perimeters and measurements 506. If the Su is exceeded the modeling process stops, a report 504 may be formatted 516, and the report 504 may be transmitted to the manager 502.

The report 504 may include the graph model, which has been optimized to reflect the dependencies observed in the data. The report 504 may be used to evaluate probabilities of some event not measured, a process called inference. In an example scenario, referring back to the Bayesian net model 424 of FIG. 4, if a visitor within a particular age group enters the merchant site 408 from the merchant site 412, the age information may be entered into the graph model to produce a table of probabilities of What the visitor is looking to buy within the merchant site 412.

The examples in FIGS. 1 through 5 have been described using specific systems and processes in which adaptive sampling of a merchant site linked to payment transactions may be implemented. Embodiments for adaptive sampling of a merchant site linked to payment transactions are not limited to the systems and processes according to these examples.

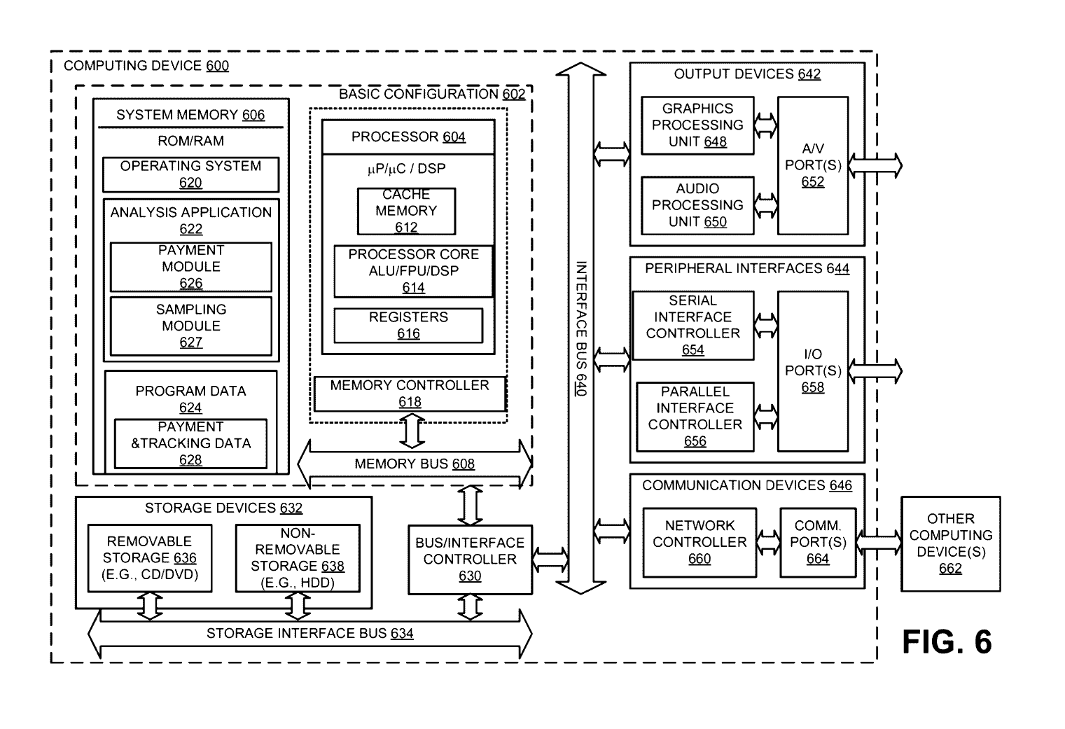

FIG. 6 illustrates a general purpose computing device, which may be used to adaptively sample a merchant site linked to payment transactions, arranged in accordance with at least some embodiments disclosed herein.

For example, a computing device 600 may be used to provide computer program products related to adaptive sampling of a merchant site linked to payment transactions. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, a processor core 614, and registers 616. The example processor core 614 may include an arithmetic logic unit AIX), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, an analysis application 622, and program data 624. The analysis application 672 may include a payment module 626 configured to record payment transactions and a sampling module 627 configured to adaptively sample a merchant site linked to the payment transactions. The program data 624 may include, among other data, payment and tracking data 628, as described herein.

The computing, device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disc (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but is not limited to RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.)

The computing device 600 may also include an interface bus 640 for facilitating communication from various interface devices for example, one or more output devices 642, one or more peripheral interfaces 644, and one or more communication devices 646) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 646 may include a network controller 660, which may be arranged to facilitate communications with one or more other computing, devices 662 over a network communication link via, one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and commination media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to adaptively sample a merchant site linked to payment transactions. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

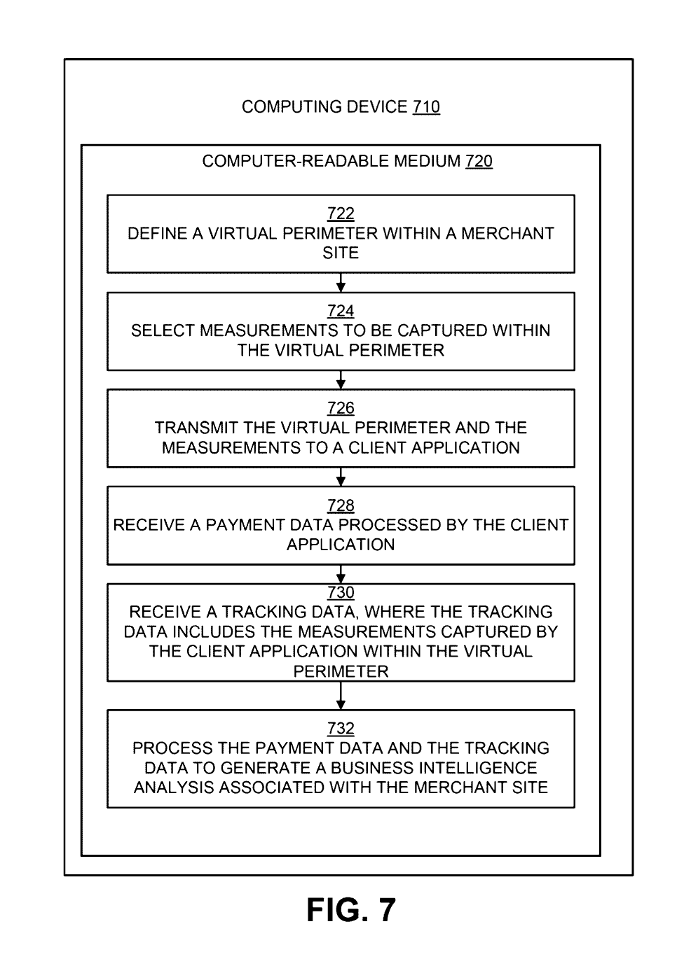

FIG. 7 is a flow diagram illustrating an example process to implement adaptive sampling of a merchant site linked to payment transactions that may be performed by a computing device such as the computing, device 600 in FIG. 6, arranged in accordance with at least some embodiments described herein.

Example methods may include one or more operations, functions, or actions as illustrated by one or more of blocks 722, 724, 726, 728, 730, and 732, and may, in some embodiments, be performed by a computing device such as the computing device 600 in FIG. 6. The operations described in blocks 722-732 may also be stored as computer-executable instructions in a computer-readable medium such 720 of a computer device 710.

An example process for providing adaptive merchant site sampling linked to payment transactions may begin with block 722. “DEFINE A VIRTUAL PERIMETER WITHIN A MERCHANT SITE,” where an analysis application (for example, the analysis application 622) of a payment network (for example, the payment network 302) may be configured to define a virtual parameter (for example, the virtual perimeter 104) to define boundaries of an area of a merchant site (for example, the merchant site 408) in which one or more measurements may be captured. The virtual perimeter may define an entire physical area of the merchant site or a portion of the physical area of the merchant site. In other examples, the virtual perimeter may define a physical area including multiple merchant sites.

Block 722 may be followed by block 724, “SELECT MEASUREMENTS TO BE CAPTURED WITHIN THE VIRTUAL PERIMETER,” where the analysis application of the payment network may further be configured to select the one or more measurements to be captured within the virtual perimeter. The measurements may be associated with activities, interactions, and behaviors of a visitor (for example, the visitor 108) within the virtual perimeter. Example measurements to be captured within the virtual perimeter may include a position, an orientation, a low frequency magnetic field, a pressure, an ambient light, a gesture, a sound, a radiofrequency connection, a cellular connection strength, software activity, a wearable attribute; and a power consumption.

Block 724 may be followed by block 726, “TRANSMIT THE VIRTUAL PERIMETER AND THE MEASUREMENTS TO A CLIENT APPLICATION,” where the analysis application may be configured to transmit the virtual perimeter and the measurements as virtual perimeter data (for example, the virtual perimeter data 206) to a client application (for example, the merchant sampling application 204). The client application may be execute on a portable device 202 (for example, the portable device 202) associated with the visitor of the merchant site. The analysis application may also be configured to provide instructions to the client application to initiate capture of the measurements in response to the client application detecting an entry of the portable device into the virtual perimeter. The analysis application may further be configured to provide instructions to the client application to stop the capture of the measurements in response to the client application detecting an exit of the portable device from the virtual perimeter.

Block 726 may be followed by block 728, “RECEIVE A PAYMENT DATA PROCESSED BY THE CLIENT APPLICATION,” where the analysis application of the payment network may be configured to receive payment data processed by the client application. The payment data may be received in response to a payment transaction executed by the portable device at a POS terminal (for example, the POS terminal 116) of the payment network.

Block 728 may be followed by block 730, “RECEIVE A TRACKING DATA, WHERE THE TRACKING DATA INCLUDES THE MEASUREMENTS CAPTURED BY THE CLIENT APPLICATION WITHIN THE VIRTUAL PERIMETER,” where the analysis application of the payment network may be configured to receive tracking data from the client application. The tracking data may include the measurements captured by the client application through one or more sensors on and/or integrated within the portable device while the portable device 202 was within the virtual perimeter.

Block 730 may be followed by block 732, “PROCESS THE PAYMENT DATA AND THE TRACKING DATA TO GENERATE A BUSINESS INTELLIGENCE ANALYSIS ASSOCIATED WITH THE MERCHANT SITE,” where the analysis application may generate a business intelligence analysis (for example the business intelligence analysis 320) based on the payment data and tracking data, where the business intelligence analysis may be consumed by a manager (for example, the manager of the 502) of the merchant site.

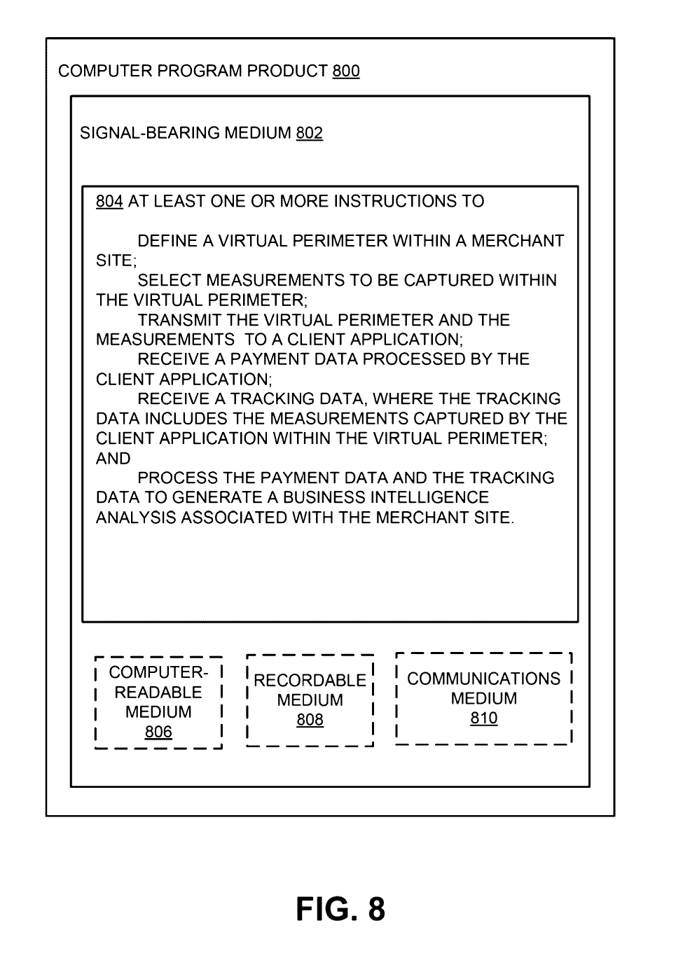

FIG. 8 illustrates a block diagram of an example computer program product to adaptively sample a merchant site linked to payment transactions, arranged in accordance with at least some embodiments described herein.

In some examples, as shown in FIG. 8, a computer program product 800 may include a signal bearing medium 802 that may also include one or more machine readable instructions 804 that, when executed by, for example, a processor, may provide the functionality described herein. For example, referring to the processor 604 in FIG. 6, the analysis application 622, the payment module 626, and the sampling module 627 may undertake one or more tasks shown in FIG. 8 in response to the instructions 804 conveyed to the processor 604 by the medium 802 to provide adaptive merchant site sampling, linked to payment transactions, as described herein. Some of those instructions may include, for example, to define a virtual perimeter within a merchant site, select measurements to be captured within the virtual perimeter, transmit the virtual perimeter and the measurements to a client application, receive a payment data processed by the client application, receive a tracking data, where the tracking data includes the measurements captured by the client application within the virtual perimeter, and process the payment data and the tracking data to generate a business intelligence analysis associated with the merchant site.

In some implementations, the signal bearing medium 802 depicted in FIG. 8 may encompass a computer-readable medium 806, such as, but not limited to, a hard disk drive, a solid state drive, a Compact Disc (CD), a Digital Versatile Disk (DVD), a digital tape, memory, etc. In some implementations, the signal bearing medium 802 may encompass a recordable medium 808, such as, but not limited to, memory, read/write (R/W) CDs, UN DVDs, etc. In some implementations, the signal bearing medium 802 may encompass a communications medium 810, such as, but not limited to, a digital and/or an analog communication medium (e.g., a fiber optic cable, a waveguide, a wired communications link, a wireless communication link, etc.). For example, the program product 800 may be conveyed to one or more modules of the processor 604 by an RF signal bearing medium, where the signal bearing medium 802 is conveyed by the wireless communications medium 810 (e.g., a wireless communications medium conforming with the IEEE 802.11 standard).

According to some examples, methods to provide adaptive merchant site sampling, linked to payment transactions are described. An example method may include defining a virtual perimeter within a merchant site; selecting measurements to be captured within the virtual perimeter; transmitting the virtual perimeter and the measurements to a client application executed on a portable device associated with a visitor of the merchant site; and receiving, a payment data processed by the client application. The method may further include receiving a tracking data; wherein the tracking data includes the measurements captured by the client application within the virtual perimeter and processing the payment data and the tracking data to generate a business intelligence analysis associated with the merchant site.

According to other examples, the method may also include processing a behavior of the visitor within the virtual perimeter as detected in the payment data and the tracking data through a Bayesian net model to generate the business intelligence analysis or processing a behavior of the visitor within the virtual perimeter as detected in the payment data and the tracking data through one or more of a hidden Markov model (HMM) and a hierarchical Dirichlet process model (HDPM) to generate the business intelligence analysis. The method may further include selecting measurements that include one or more of a position, an orientation, a low frequency magnetic field, a pressure, an ambient light, a gesture, a sound, a radiofrequency connection, a cellular connection strength, a software activity, a wearable attribute, and a power consumption.

According to further examples, the method may include providing, instructions to the client application to initiate capture of the measurements in response to the client application detecting an entry of the portable device into the virtual perimeter and/of providing instructions to the client application to stop the capture of the measurements, and transmit the tracking data in response to the client application detecting an exit of the portable device from the virtual perimeter. The method may also include analyzing movements of the visitor captured in the tracking data to include in the business intelligence analysis.

According to yet other examples, the method may include analyzing ambient sound captured in the tracking data to detect a noise level within the virtual perimeter to include within the business intelligence analysis and/or analyzing biological data associated with the visitor captured in the tracking data to detect one or more moods of the visitor within the virtual perimeter to include in the business intelligence analysis. The method may also include dynamically updating the virtual perimeter and the measurements based on the business intelligence analysis and/or predicting a product to be purchased by the visitor associated with the tracking, data and the payment data based on the business intelligence analysis.

According to other examples, a portable device capable to adaptively sample a merchant site linked to payment transactions is described. An example portable device may include a wireless network device, a memory, and a processor coupled to the memory and the wireless network device. The processor may execute a merchant sampling application in conjunction with instructions stored in the memory. The merchant sampling application may be configured to receive a virtual perimeter and measurements to be captured within the virtual perimeter from a payment server; detect an entry of the portable device into the virtual perimeter; initiate capture of the measurements; detect a payment event at a payment terminal; transmit, through the wireless network device, a payment data associated with the payment event to the payment server; and detect an exit of the portable device from the virtual perimeter. The merchant sampling application may be further configured to stop capturing the measurements, wherein the captured measurements are packaged as a tracking data and transmit, through the wireless network device, the tracking data to the payment server to initiate operations to analyze the tracking data and the payment data to generate a business intelligence analysis by the payment server.

According to some examples, the merchant sampling application may be further configured to access global positioning system (GPS) data of the portable device to track movement within the virtual perimeter; synchronize an estimated current position with a position data of the payment terminal at a time of the payment event; and activate one or more sensors associated with the measurements to capture the measurements during a time period as specified by the measurements, where the one or more sensors are positioned on or integrated within the portable device. The merchant sampling application may also be configured to anonymize attributes of a visitor associated with the portable device based on one or more privacy preferences of the visitor and capture demographics of the visitor to include in the tracking data, where the demographics include one or more of an age, a gender, an income status and a purchase history of the visitor.

According to yet other examples, the merchant sampling application may be further configured to capture a point of sale (POS) parameters into the payment data, wherein the POS parameters include one or more of a position of the payment terminal; a form of payment, a time of payment, a number of products purchased, a list of the products purchased, and an amount of payment. The merchant sampling application may also be configured to discontinue access to global positioning system (GPS) data of the portable device to track movement outside of the virtual perimeter; and access a location data provided by a mobile network operator to track movement outside of the virtual perimeter.

According to further examples, a payment server capable to analyze adaptive merchant site sampling linked to payment transactions is described. The payment server may include a network device, a memory, and a processor coupled to the memory and the network device. The processor may execute an analysis application, which may be configured to define a virtual perimeter within a merchant site; select measurements to be captured within the virtual perimeter; transmit, through the network device, the virtual perimeter and the measurements to a client application executed on a portable device associated with a visitor of the merchant site; and receive, at the network device, a payment data processed by the client application. The analysis application may also be configured to receive, at the network device, a tracking data, where the tracking data includes the measurements captured by the client application within the virtual perimeter; and processing the payment data and the tracking data to generate a business intelligence analysis associated with the merchant site.

According to some examples, the analysis application may be further configured to provide instructions to the client application to initiate capture of the measurements in response to detecting an entry of the portable device into the virtual perimeter; and provide instructions to the client application to stop capture of the measurements, and transmit the tracking data in response to detecting an exit of the portable device from the virtual perimeter. The analysis application may also be configured to analyze movements of the visitor captured in the tracking data to include in the business intelligence analysis; analyze ambient sound captured in the tracking data to detect a noise level within the virtual perimeter to include within the business intelligence analysis; and analyze biological data associated with the visitor captured in the tracking data to detect one or more moods of the visitor within the virtual perimeter to include in the business intelligence analysis. The virtual perimeter and the measurements may be dynamically updated based on the business intelligence analysis.

The use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof, in one embodiment, several portions of the subject matter described herein may be implemented via Application Specific. Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent techniques and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing, medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A typical data processing system may be implemented using any suitable commercially available components, such as those typically found in data computing/communication and/or network computing/communication systems. The herein described subject matter sometimes illustrates different components contained within, or connected with, different other components. Such depicted architectures are merely exemplary, and that in fact many other architectures may be implemented which achieve the same functionality, in a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds tare for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used in general such a construction is intended in the sense one having skill in the art would understand the convention (for example, “a system having at least one of A, B, and C” would include but not be limited to systems that have A alone, B alone, C alone, A and B together A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various compositions, techniques, systems, and devices are described in terms of “comprising” various components or steps (interpreted as meaning “including, but not limited to”), the compositions, techniques, systems, and devices can also “consist essentially of” or “consist of” the various components and steps, and such terminology should be interpreted as defining, essentially closed-member groups.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being, indicated by the following claims.

1. A method to provide adaptive merchant site sampling linked to payment transactions, the method comprising:
defining a virtual perimeter within a merchant site;
selecting measurements to be captured within the virtual perimeter;
transmitting the virtual perimeter and the measurements to a client application executed on a portable device associated with a visitor of the merchant site;
receiving a payment data processed by the client application;
receiving a tracking data, wherein the tracking data includes the measurements captured by the client application within the virtual perimeter; and
processing the payment data and the tracking data to generate a business intelligence analysis associated with the merchant site.

2. The method of claim 1, further comprising:
processing a behavior of the visitor within the virtual perimeter as detected in the payment data and the tracking data through a Bayesian net model to generate the business intelligence analysis.

3. The method of claim 1, further comprising:
processing a behavior of the visitor within the virtual perimeter as detected in the payment data and the tracking data through one or more of a hidden Markov model (HMM) and a hierarchical Dirichlet process model (HDPM) to generate the business intelligence analysis.

4. The method of claim 1, further comprising:
selecting, measurements that include one or more of a position, an orientation, a low frequency magnetic field, a pressure, an ambient light, a gesture, a sound, a radiofrequency connection, a cellular connection strength, a software activity, a wearable attribute, and a power consumption.

5. The method of claim 1, further comprising:
providing instructions to the client application to initiate capture of the measurements in response to the client application detecting an entry of the portable device into the virtual perimeter.

6. The method of claim 5, further comprising:
providing instructions to the client application to stop the capture of the measurements, and transmit the tracking data in response to the client application detecting an exit of the portable device from the virtual perimeter.

7. The method of claim 1, further comprising:
analyzing movements of the visitor captured in the tracking data to include in the business intelligence analysis.

8. The method of claim 1, further comprising:
analyzing ambient sound captured in the tracking data to detect a noise level within the virtual perimeter to include within the business intelligence analysis.

9. The method of claim 1, further comprising:
analyzing biological data associated with the visitor captured in the tracking data to detect one or more moods of the visitor within the virtual perimeter to include in the business intelligence analysis.

10. The method of claim 1, further comprising:
dynamically updating the virtual perimeter and the measurements based on the business intelligence analysis.

11. The method of claim 1, further comprising:
predicting a product to be purchased by the visitor associated with the tracking data and the payment data based on the business intelligence analysis.

12. A portable device capable to adaptively sample a merchant site linked to payment transactions, the portable device comprising:
a wireless network device;
a memory;
a processor coupled to the memory and the wireless network device, the processor executing a merchant sampling application in conjunction with instructions stored in the memory, wherein the merchant sampling application is configured to:
receive a virtual perimeter and measurements to be captured within the virtual perimeter from a payment server;
detect an entry of the portable device into the virtual perimeter;
initiate capture of the measurements;
detect a payment event at a payment terminal;
transmit, through the wireless network device, a payment data associated with the payment event to the payment server;
detect an exit of the portable device from the virtual perimeter;
stop capturing the measurements, wherein the captured measurements are packaged as a tracking data; and
transmit, through the wireless network device, the tracking data to the payment server to initiate operations to analyze the tracking data and the payment data to generate a business intelligence analysis by the payment server.

13. The portable device of claim 12, wherein the merchant sampling application is further configured to:
access global positioning system (GPS) data of the portable device to track movement within the virtual perimeter.

14. The portable device of claim 12, wherein the merchant sampling application is further configured to:
synchronize an estimated current position with a position data of the payment terminal at a time of the payment event.

15. The portable device of claim 12, wherein the merchant sampling application is further configured to:
activate one or more sensors associated with the measurements to capture the measurements during a time period as specified by the measurements, wherein the one or more sensors are positioned on or integrated within the portable device.

16. The portable device of claim 12, wherein merchant sampling application is further configured to:
anonymize attributes of a visitor associated with the portable device based on one or more privacy preferences of the visitor; and
capture demographics of the visitor to include in the tracking data, wherein the demographics include one or more of an age, a gender, an income status and a purchase history of the visitor.

17. The portable device of claim 12, wherein the merchant sampling application is further configured to:
capture a point of sale (POS) parameters into the payment data, wherein the POS parameters include one or more of a position of the payment terminal, a form of payment, a time of payment, a number of products purchased, a list of the products purchased, and an amount of payment.

18. The portable device of claim 12, wherein the merchant sampling application is further configured to:
discontinue access to global positioning system (GPS) data of the portable device to track movement outside of the virtual perimeter; and
access a location data provided by a mobile network operator to track movement outside of the virtual perimeter.

19. A payment server capable to analyze adaptive merchant site sampling linked to payment transactions, the payment server comprising:
a network device;
a memory;
a processor coupled to the memory and the network device, the processor executing an analysis application, wherein the analysis application is configured to:
define a virtual perimeter within a merchant site;
select measurements to be captured within the virtual perimeter;
transmit, through the network device, the virtual perimeter and the measurements to a client application executed on a portable device associated with a visitor of the merchant site;
receive, at the network device, a payment data processed by the client application;
receive, at the network device, a tracking data, wherein the tracking data includes the measurements captured by the client application within the virtual perimeter, and
processing the payment data and the tracking data to generate a business intelligence analysis associated with the merchant site.

20. The payment server of claim 19, wherein the analysis application, is further configured to:
provide instructions to the client application to initiate capture of the measurements in response to detecting an entry of the portable device into the virtual perimeter; and
provide instructions to the client application to stop capture of the measurements, and transmit the tracking data in response to detecting, an exit of the portable device from the virtual perimeter.

21-22. (canceled)
